(19) United States
(12) Patent Application Publication
(10) Pub. No.: US 2025/0305769 A1
(43) Pub. Date: Oct. 2, 2025

(54) SWIMMING GOGGLES CASE WITH IMPROVED USE OF CONVENIENCE AND DRYING FUNCTION

(71) Applicant: JONG-MAN KIM, Anyang-si (KR)

(72) Inventor: JONG-MAN KIM, Anyang-si (KR)

(21) Appl. No.: 18/757,563

(22) Filed: Jun. 28, 2024

(30) Foreign Application Priority Data
Mar. 29, 2024 (KR) 10-2024-0043680

(51) Int. Cl. F26B 25/18; A63B 33/00; B65D 81/26; B65D 85/18

(52) U.S. Cl. CPC F26B 25/18; B65D 81/26; B65D 85/18; A63B 33/002

(57) ABSTRACT

The present technology relates to a swimming goggles case manufactured to have a simpler shape compared to the related art so as to be easily used and satisfy a structure for facilitating drying of an anti-moisture agent or moisture present in a lens, and more particularly, the swimming goggles case for storing swimming goggles includes: a pair of lens protection bodies for surrounding a pair of lenses constituting the swimming goggles; a joint body for connecting facing one sides of the lens protection bodies to each other to allow a connecting portion constituting the swimming goggles to be inserted therethrough; and band insertion bodies extending from opposite sides of the lens protection bodies, respectively, to allow a band constituting the swimming goggles to be inserted therethrough.

### CROSS-REFERENCE TO RELATED APPLICATIONS

This U.S. non-provisional patent application claims priority under 35 U.S.C. § 119 of Korean Patent Application No. 10-2024-0043680, filed on Mar. 29, 2024, the entirety of which are hereby incorporated by reference.

### TECHNICAL FIELD

The present technology relates to a swimming goggles case manufactured to have a simpler shape compared to the related art so as to be easily used and satisfy a structure for facilitating drying of an anti-moisture agent or moisture present in a lens.

### BACKGROUND ART

In general, swimming goggles used for swimming or playing in the water are stored in a goggles case to prevent deformation after use and protect lenses.

The conventional swimming goggles case is formed in a sealed plastic form and configured to be opened and closed by a separate opening and closing member to allow swimming goggles to be inserted thereto.

However, the production of the separate opening and closing member may be inconvenient, a unit price of the swimming goggles case may be increased due to high production costs, and it may be inconvenient to use the swimming goggles case.

In addition, the conventional swimming goggles cases formed of a hard material may be easily damaged when dropped and a sealed structure may cause the swimming goggles to be dried improperly after use, and accordingly remaining moisture containing foreign substances may damage a lens or a swimming goggles body and generate odor.

In addition, the inconvenience of opening and closing a cover is also required even for a swimming goggles case product having an opening and closing structure using the cover.

### DOCUMENT OF RELATED ART

Korean Utility Model Registration No. 0492648 (Publication date: Nov. 16, 2020)
Korean Patent Registration No. 2641450 (Publication date: Feb. 27, 2024)
Korean Utility Model Registration No. 0476883 (Publication date: Apr. 10, 2015)
Korean Patent Registration No. 0446210 (Publication date: Nov. 8, 2004)

### DISCLOSURE

### Technical Problem

In order to solve the above-mentioned conventional problems, an object of the present invention is to provide a swimming goggles case for reducing a producing cost to lower a unit price, preventing a breakage, and facilitating a dry of the swimming goggles case.

### Technical Solution

In order to solve the above-mentioned conventional problems, swimming goggles case with improved use of convenience and drying function for storing swimming goggles (10) according to the present invention includes: a pair of lens protection bodies (100) for surrounding a pair of lenses (11) constituting swimming goggles (10); a joint body (200) for connecting facing one sides of the lens protection bodies (100) to each other to allow a connecting portion (13) constituting the swimming goggles (10) to be inserted therethrough; and band insertion bodies (300) extending from opposite sides of the lens protection bodies (100), respectively, to allow a band (15) constituting the swimming goggles (10) to be inserted therethrough.

In addition, each of the lens protection bodies (100) may be formed with an insertion groove (110) to which the lens (11) is inserted and shape-fitted, and a rear of the insertion groove (110) may be opened.

In addition, the joint body (200) may include an incision portion (210) incised to allow the connecting portion (13) to enter and exit, and a through-hole (220) for communicating with the incision portion (210) to allow the connecting portion (13) to be inserted therethrough, in which a plurality of through-holes (220) may be formed to have different diameters and communicate with each other in the joint body (200).

In addition, each of the band insertion bodies (300) includes a pair of protrusions (310) protruding from upper and lower portions of the lens protection body (100), respectively, to face and continue each other, and a pair of grooves (320) formed on outer surfaces of the protrusions (310) facing each other, respectively, in which the pair of grooves (320) may be formed to have a perforated long hole shape to allow the band (15) to be inserted therethrough, and the pair of protrusions (310) facing each other may be formed therein with ends for forming an incision gap (311) communicating with the grooves (320), respectively, to allow the band (15) to inwardly enter and outwardly exit the band insertion body (300).

In addition, the swimming goggles case may be formed of an elastic silicone material, in which the joint body (200) may have elasticity harder than elasticity of the lens protection body (100) or the band insertion body (300).

### Advantageous Effects

According to the present invention, differently from the related art, the swimming goggles may be accommodated in the lens protection bodies while covering the outer surface of the pair of lenses without damage, so that the user can easily grasp or carry the swimming goggles through the band insertion bodies, and the swimming goggles may be stored by selectively passing the connecting portion through the through-holes formed in the joint body and having different sizes, so that production costs can be reduced, thereby lowering unit costs.

In addition, differently from the related art, the rear of the insertion groove formed in each of the pair of lens protection bodies may have an open structure so as to be exposed to the outside air, so that the moisture, the anti-moisture agent and the like present on the inner surface of the lens can be easily dried.

In addition, differently from the related art, the open structure may be satisfied in which an opening and closing structure for accommodating the swimming goggles is not present, so that the inconvenience for use can be eliminated.

### DESCRIPTION OF DRAWINGS

FIG. 1 is a front perspective view showing a swimming goggles case with an improved use of convenience and a drying function according to the present invention.

FIG. 2 is a rear perspective view of FIG. 1.

FIG. 3 is an enlarged view of a band insertion body of FIG. 2.

FIG. 4 is a rear view of FIG. 2.

FIG. 5 is a sectional plan view of FIG. 4.

### BEST MODE

### Mode for Invention

Hereinafter, various embodiments will be described in more detail with reference to the accompanying drawings. The embodiments described in the present specification may be variously modified. Specific embodiments will be illustrated in the drawings and described in the detailed description in detail. However, the specific embodiments disclosed in the accompanying drawings are merely intended to provide the further understanding of various embodiments. Therefore, it will be understood that the specific embodiments disclosed in the accompanying drawings do not limit the technical idea and may include all equivalents or substitutes included in the spirit and technical scope of the present invention.

The terms including an ordinal number such as first and second may be used to describe various components, however, these components are not limited by the above-mentioned terms. The above terms are used only for the purpose of distinguishing one component from another component.

In the present specification, it will be understood that the term such as “include” or “have” is intended to designate the presence of a feature, number, step, component, part or a combination thereof recited in the specification, and does not preclude the possibility of the presence or addition of one or more other features, numbers, steps, components, parts or combinations thereof. When one component is recited to be “connected” or “linked” to other component, it will be understood that the one component may be directly connected to or linked to the other component, but another component may be present therebetween. On the other hand, when it is mentioned that one component is “directly connected” or “directly linked” to other component, it will be understood that another component is not present therebetween.

Further, in the following description of the embodiments of the present invention, the detailed description of the related known function or configuration incorporated herein will be shortened or omitted when it possibly makes the subject matter of the present invention unclear unnecessarily.

Hereinafter, a swimming goggles case with an improved use of convenience and a drying function (hereinafter simply referred to as “case”) according to the present invention will be described in detail with reference to the accompanying drawings.

Prior to the description, the case 1 in the present invention may be formed using a synthetic resin material, such as silicone, having elasticity and colored as needed. The swimming goggles are used as an embodiment, however this is merely one embodiment, and it is noted that, the embodiment may also be applied to goggles used in sports such as skiing or snowboarding if necessary.

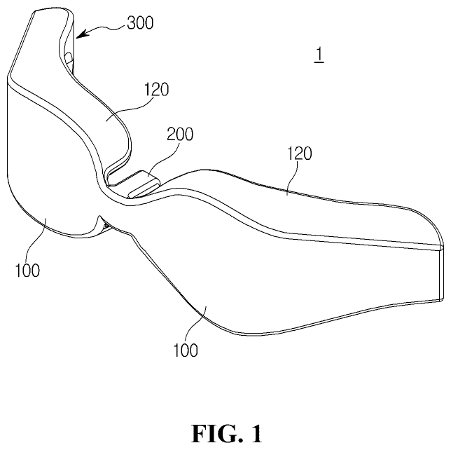

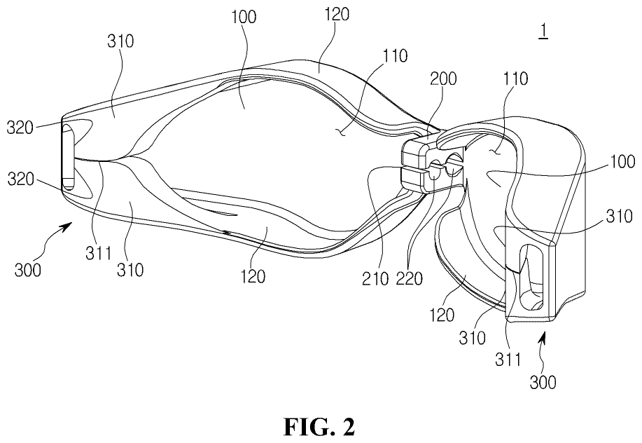

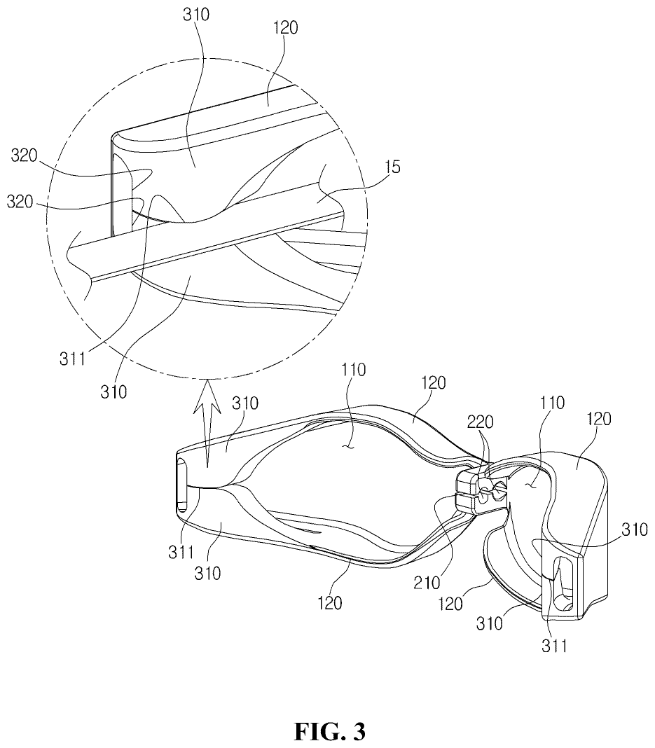

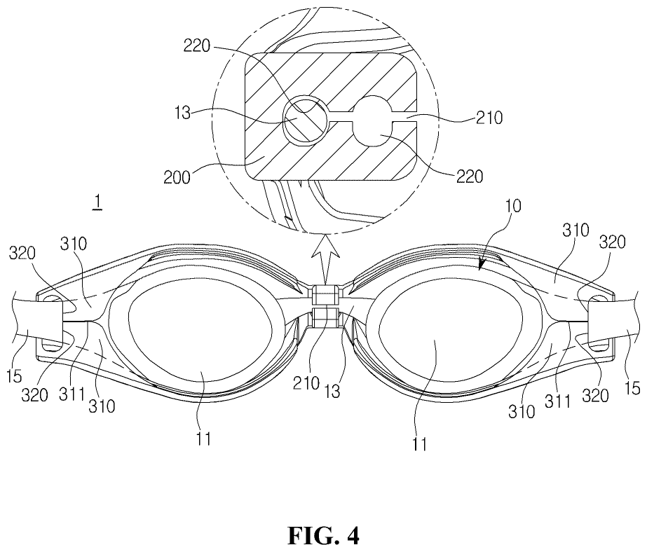

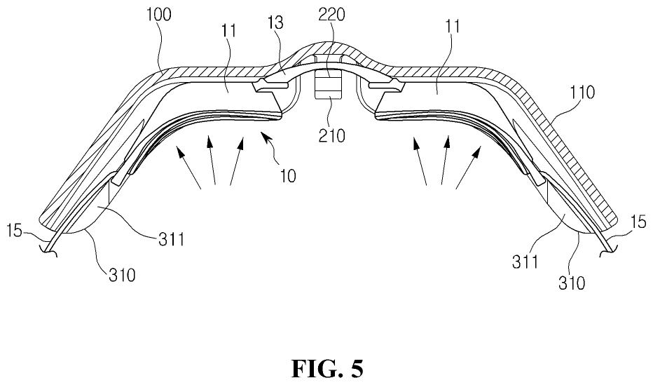

First, as shown in FIGS. 1 to 5, the case 1 according to the present invention largely includes lens protection bodies 100, a joint body 200, and band insertion bodies 300.

More specifically, the lens protection bodies 100 includes an insertion groove 110 and an extension portion 120 which are configured to store the goggles 10 so that a pair of lenses 11 constituting the goggles 10 are protected and to facilitate drying of moisture by external air and drying of moisture remover (anti-fog) applied onto insides of the lens 11.

For example, as shown in the drawings, a pair of lens protection bodies 100 are formed to have sides facing each other, respectively, and connected to the joint body 200 described later to surround outer surfaces of the swimming goggles 10.

To this end, the insertion groove 110 may be formed inside each of the lens protection bodies 100 to allow an outer surface of the lens 11 to be inserted thereto with an interference fit or the like, and the insertion groove 110 may be molded to be deformable according to a shape of the lens 11.

A rear side of each insertion groove 110 is in an open state to come into contact with the outside air, so that drying may be easily performed not only on moisture on an inner surface of the lens 11 but also on a moisture coating agent applied to the inner surface of the lens 11.

The pair of lens protection bodies 100 and the pair of lenses 11 provided in the swimming goggles 10 are coupled to each other, respectively, in an interference fit manner, so that a user may easily move and store the swimming goggles 10 by simply gripping a band 15 provided in the swimming goggles 10 while accommodating the swimming goggles 10 in the case 1.

In addition, the lens protection body 100 according to the present invention my further include the extension portions 120 extending in a rearward direction from upper and lower portions of each of the lens protection bodies 100 to prevent the outer surface of the lens 11 from being exposed to the outside.

Accordingly, damages such as scratches on the entire outer surface of the lens 11 may be prevented even when the case 1 containing the swimming goggles 10 falls on the floor or the like.

Thus, the lens protection body 100 in the present invention satisfies an overall open structure, so that the inconvenience of opening a cover or the like may be eliminated and the drying effect may be maximized, compared to the related art.

In addition, the joint body 200 connects the above-described pair of lens protection bodies 100 to each other, and includes an incision portion 210 and a through-hole 220 which are configured to allow the connecting portion 13 constituting the swimming goggles 10 to be inserted therethrough so that the swimming goggles 10 accommodated in the case 1 are prevented from being separated, together with the extension portion 120.

For example, the joint body 200 may be molded to be harder compared to the lens protection body 100 described above or the band insertion body 300 described later, which have elastic force, and accordingly, the connecting portion 13 inserted into the through-hole 220 may be prevented from being separated from the through-hole 220 when the user is moving while carrying the case 1.

As shown in the drawings, the incision portion 210 satisfies a structure incised from an outer surface of the joint body 200 to communicate with at least two through-holes 220 formed in the joint body 200, so as to allow entry and exit through any one of the through-holes 220 according to a size of the connecting portion 13.

To this end, the through-holes 220 perforated in the joint body 200 may be formed to have different hole sizes. In the present invention, a circular perforated shape is used as an example, however, this is merely one embodiment, and a rectangular shape may be formed depending on the shape of the connecting portion 13.

Although not shown, a plurality of protrusions (not shown) may protrude inside each of the through-holes 220, so that the outer surface of the connecting portion 13 inserted therethrough is pressed to improve fixing force between the swimming goggles 10 and the case 1.

In addition, as shown in the drawings, the band insertion body 300 is formed continuously to the extension portion 120 formed on an opposite side of each of the lens protection bodies 100 other than the sides connected to each other by the joint body 200, to allow the band 15 constituting the swimming goggles 10 to be inserted therethrough, thereby facilitating portability of the swimming goggles 10 accommodated in the case 1. To this end, the band insertion body 300 includes a protrusion 310 and a groove 320.

For example, a pair of protrusions 310 are formed on the opposite side of each of the lens protection bodies 100 so as to extend upward and downward from the extension portions 120 formed at the upper and lower portions, respectively.

The pair of protrusions 310 extending upward and downward may have ends forming an incision gap 311 to come into surface-contact with each other to allows the band 15 to enter from the outside of the case 1.

The band 15 freely enters and exits through the incision gap 311, so that the storage between the case 1 and the swimming goggles 10 may be easily implemented.

In addition, the grooves 320 are perforated on outer surfaces of the protrusions 310, respectively, protruding to have the incision gap 311 to have a symmetrical structure of allowing the grooves 320 through which the band 15 introduced through the incision gap 311 is inserted to face each other, in which the pair of grooves 320 facing each other may have a long hole shape in consideration of a shape of the band 15.

As described above, differently from the related art, the case 1 according to the present invention can accommodate the swimming goggles 10 in the lens protection bodies 100 while covering the outer surface of the pair of lenses 11 without damage, and the user can easily grasp or carry the swimming goggles through the band insertion bodies 300. The swimming goggles 10 can be stored by selectively passing the connecting portion 13 through the through-holes 220 formed in the joint body 200 and having different sizes, so that production costs can be reduced, thereby lowering unit costs.

In addition, differently from the related art, the rear of the insertion groove 110 formed in each of the pair of lens protection bodies 100 has an open structure so as to be exposed to the outside air, so that the moisture, the anti-moisture agent and the like present on the inner surface of the lens 11 can be easily dried.

In addition, differently from the related art, the open structure in which an opening and closing structure for accommodating the swimming goggles is not present, so that the inconvenience for use can be eliminated.

The present invention has been described with reference to the limited embodiments, drawings and particular items such as specific components, but it will be understood that the above description has been merely provided for further understanding the present invention, the embodiments do not limit the present invention, and various changes and modifications may be made by those skilled in the art.

Therefore, the idea of the present invention will not be determined by the aforementioned embodiments only, and the following claims as well as all modifications or variations belonging to the equivalents of the claims will be within the scope of the invention.

[Description of Reference Numerals]

| | |
|---|---|
| 1: Swimming goggles case with | |
| improved use of convenience and | |
| drying function according to | |
| the present invention | |
| 100: Lens protection body | 110: Insertion groove |
| 120: Extension portion | 200: Joint body |
| 210: Incision portion | 220: Through-hole |
| 300: Band insertion body | 310: protrusion |
| 311: Incision gap | 320: Groove |
| 10: Swimming goggles | 11: Lens |
| 13: Connecting portion | 15: Band |

1. A swimming goggles case capable of storing swimming goggles (10) and having an improved use of convenience and a drying function, the swimming goggles case comprising:
a pair of lens protection bodies (100) for surrounding a pair of lenses (11) constituting the swimming goggles (10);
a joint body (200) for connecting facing one sides of the lens protection bodies (100) to each other to allow a connecting portion (13) constituting the swimming goggles (10) to be inserted therethrough; and
band insertion bodies (300) extending from opposite sides of the lens protection bodies (100), respectively, to allow a band (15) constituting the swimming goggles (10) to be inserted therethrough.

2. The swimming goggles case of claim 1, wherein each of the lens protection bodies (100) is formed therein with an insertion groove (110) to which the lens (11) is inserted and shape-fitted, in which the insertion groove (110) has an open rear.

3. The swimming goggles case of claim 1, wherein the joint body (200) includes:
an incision portion (210) incised to allow the connecting portion (13) to enter and exit; and
a plurality of through-holes (220) communicating with the incision portion (210) and through which the connecting portion (13) is inserted, in which the through-holes (220) have different diameters to communicate with each other in the joint body (200).

4. The swimming goggles case of claim 1, wherein each of the band insertion bodies (300) includes:
a pair of protrusions (310) protruding from upper and lower portions of the lens protection body (100), respectively, to face and continue each other; and
a pair of grooves (320) formed on outer surfaces of the protrusions (310) facing each other, respectively, in which the pair of grooves (320) are formed to have a perforated long hole shape to allow the band (15) to be inserted therethrough, and the pair of protrusions (310) facing each other are formed therein with ends for forming an incision gap (311) communicating with the grooves (320), respectively, to allow the band (15) to inwardly enter and outwardly exit the band insertion body (300).

5. The swimming goggles case of claim 1, wherein the swimming goggles case is formed of an elastic silicone material, in which the joint body (200) has elasticity harder than elasticity of the lens protection body (100) or the band insertion body (300).
